(19) United States
(12) Patent Application Publication
(10) Pub. No.: US 2011/0010465 A1
(43) Pub. Date: Jan. 13, 2011

(54) Methods and Systems for Providing Template Based Compression

(76) Inventors: Andrea G Forte, Brooklyn, NY (US); Henning Schulzrinne, Leonia, NJ (US)

Correspondence Address: Byrne Poh LLP, 11 Broadway, Ste 865, New York, NY, 10004, US

(21) Appl. No.: 12/669,377

(22) PCT Filed: Jul. 18, 2008
(86) PCT No.: PCT/US08/70499

§ 371 Date: Sep. 10, 2010

Related U.S. Application Data
(60) Provisional application No. 60/950,546, filed on Jul. 18, 2007.

(51) Int. Cl. G06F 15/16

(52) U.S. Cl. 709/246

(57) ABSTRACT

Methods and systems for providing template based compression are proxided. In some embodiments, methods for providing template based compression on a message having headers and corresponding values are provided, the methods comprising stripping a first portion of the headers and the corresponding values from the message, filtering a second portion of the headers and the corresponding values from the message based on the contents of a template; substituting a third portion of corresponding values in the message with indices from a dictionary corresponding to the third portion of corresponding values; encoding the indices and a fourth portion of the corresponding values into a packet in a different relative order than the corresponding values are arranged in the message, and transmitting the packet to a recipient.

### CROSS REFERENCE TO RELATED APPLICATION

This application claims the benefit of U.S. Provisional Patent Application No. 60/950,546, filed Jul. 18, 2007, which is hereby incorporated by reference herein in its entirety.

### TECHNICAL FIELD

The disclosed subject matter relates to methods and systems for providing template based compression.

### BACKGROUND

Digital communications play an ever increasing part of the everyday lives of people around the world. For example, virtually all mobile telephones today utilize digital communications to enable users to speak to one another. With advances in multimedia, these mobile telephones, and other portable multimedia devices, are also able to perform other tasks such as presenting streaming audio and video, providing video conferencing functions, etc.

Various protocols are used to facilitate digital communications. For example, the Session Initiation Protocol (SIP), defined in RFC 3261 from the Internet Engineering Task Force (IETF), which is hereby incorporated by reference herein in its entirety, is widely used for various forms of digital communications, such as Voice over Internet Protocol (VoIP) for instance.

In many cases, these protocols use long message formats. For example, some SIP based messages can have message sizes that are over INX) bytes in length. Unfortunately, these long message formats can significantly negatively impact a user's experience when digital communications are being performed using certain technologies. For example, long message lengths can lengthen the time required to setup a call with many technologies. Such lengthened times are undesirable to users, especially when using technologies such as “Push-To-Talk over Cellular (POC)” in which near-instant communication is desired by users.

### SUMMARY

Methods and systems for providing template based compression are provided. In some embodiments, methods for providing template based compression on a message having headers and corresponding values are provided, the methods comprising: stripping a first portion of the headers and the corresponding values from the message; filtering a second portion of the headers and the corresponding values from the message based on the contents of a template; substituting a third portion of corresponding values in the message with indices from a dictionary corresponding to the third portion of corresponding values; encoding the indices and a fourth portion of the corresponding values into a packet in a different relative order than the corresponding values are arranged in the message; and transmitting the packet to a recipient.

In some embodiments, systems for providing template based compression on a message having headers and corresponding values are provided, the systems comprising: user equipment that: strips a first portion of the headers and the corresponding values from the message: filters a second portion of the headers and the corresponding values from the message based on the contents of a template; substitutes a third portion of corresponding values in the message with indices from a dictionary corresponding to the third portion of corresponding values; encodes the indices and a fourth portion of the corresponding values into a packet in a different relative order than the corresponding values are arranged in the message; and transmits the packet to a recipient.

### BRIEF DESCRIPTION OF THE DRAWINGS

FIG. 1 is a diagram of an illustrative process for conveying messages using template based compression in accordance with some embodiments.

FIG. 2 is a diagram of an illustrative format for a packet in accordance with some embodiments.

FIG. 3 is a table showing examples of different SIP headers and whether those headers may be stripped, whether those headers are software or hardware dependent, whether those headers have finite sets of values, and what those headers may use as typical values in accordance with some embodiments.

FIG. 4 is a table showing examples of different SIP headers, possible classifications for those headers, and the frequency of occurrence of those headers in accordance with some embodiments.

FIG. 5 is a diagram of example hardware in which template based compression can be use in accordance with some embodiments.

FIG. 6 is a diagram of one example of a SIP call setup process in accordance with the prior art and some embodiments.

FIG. 7 is a diagram illustrating an example of a SIP Invite message in accordance with the prior art and some embodiments.

### DETAILED DESCRIPTION

In accordance with various embodiments, as described in more detail below, mechanisms for providing template-based compression are provided. In some embodiments, for example, template-based compression can be used to send standard message formats between compatible devices. One such standard message may be a Session Initiation Protocol (SIP) Invite message for example. Rather than sending the entire message, a portion of the Invite message can be represented by a template that is known to a sender and a recipient. This portion can include message content that is static or likely to not change. Other content can be represented by a packet sent between the sender and the recipient. The content in the packet can be compressed and/or encoded in any suitable manner. Once received, this packet can be decoded and/or decompressed and combined with the template to form the desired message. The message can then be used as desired. In this way, the amount of data needed to be transmitted between the sender and the recipient at a required instant can be reduced to data that cannot be known in advance.

Although various embodiments are described herein in connection with Session Initiation Protocol (SIP) messages, and in particular SIP Invite messages, it should be apparent that the mechanisms described can be implemented with any suitable protocol and any suitable messages within that protocol.

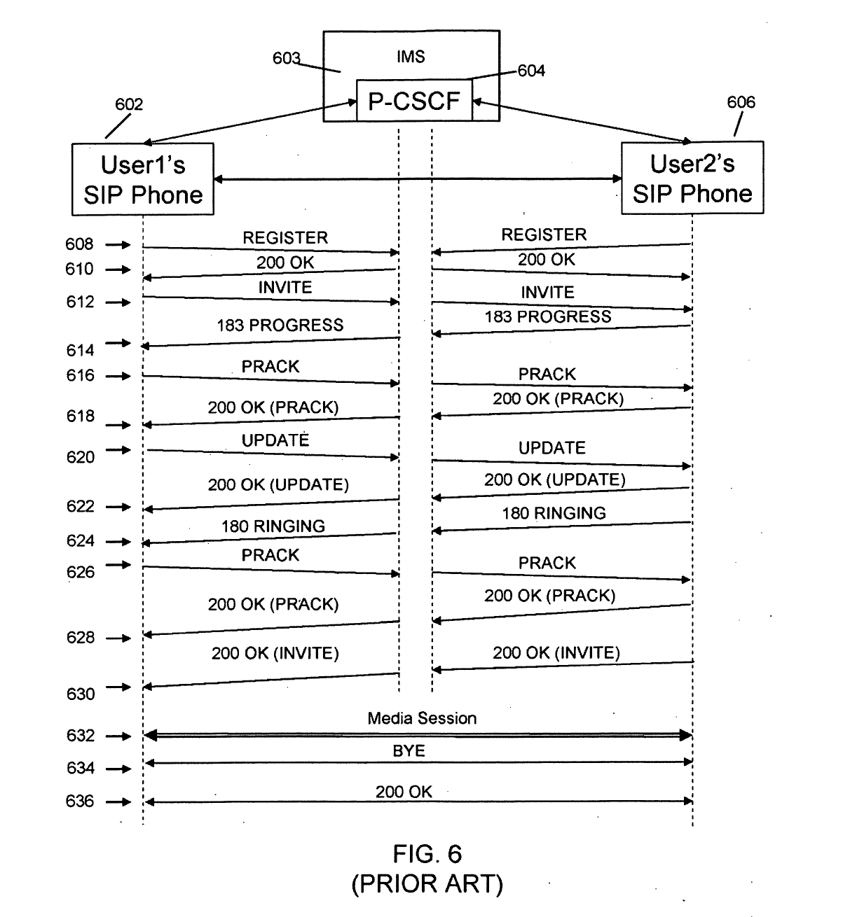

Turning to FIG. 6, a diagram illustrating a Session Initiation Protocol (SIP) call setup as known in the prior art is shown. As illustrated, a User1's SIP phone 602 can communicate with a Proxy-Call Session Control Function (P-CSCF) 604 in an IP Multimedia Subsystem (IMS) 603 to setup a call with a User2′s SIP phone 606. In order to do so, phones 602 and 606 send “Register” messages to P-CSCF 604 at 608, and receive “200 OK” messages at 610 as part of a registration process. Then, at 612, phone 602 sends an “Invite” message to P-CSCF 604, and P-CSCF 604 sends the “Invite” message to phone 606. In response, “183 Progress” messages are sent at 614, “PRACK” messages are sent at 616, “200 OK (PRACK)” messages are sent at 618, “Update” messages are sent at 620, “200 OK (Update)” messages are sent at 622, “180 Ringing” messages are sent at 624, “PRACK” messages are sent at 626, “200 OK (PRACK)” messages are sent at 628, and “200 OK (Invite)” messages are sent at 630. Upon receipt of the “200 OK (Invite)” message at Phone 602, a bearer channel is setup between phones 602 and 606. This enables a media session to be conducted between the phones at 632. When the media session is complete, the phones may exchange “Bye” messages at 634 and “200 OK” messages at 636.

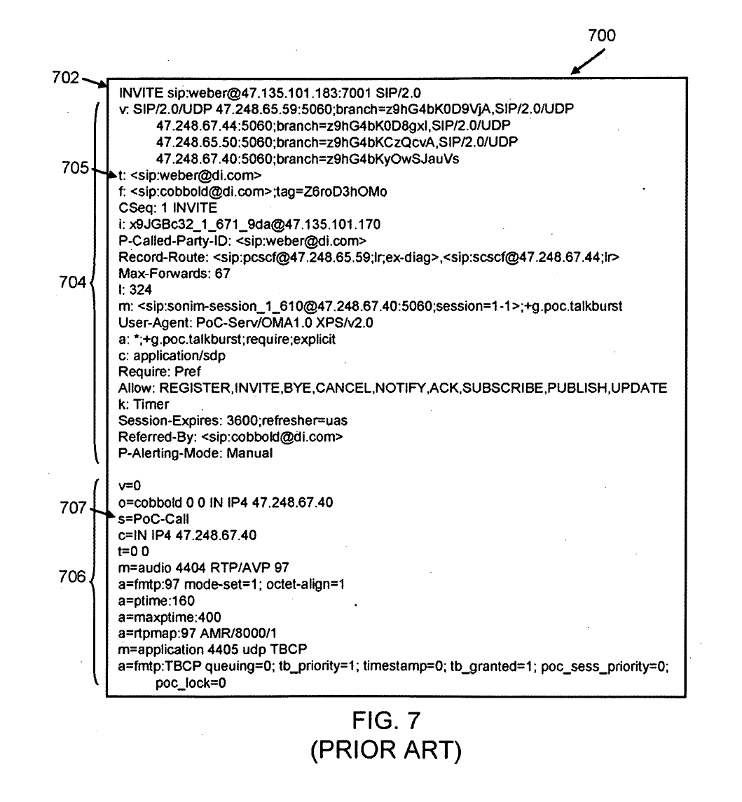

FIG. 7 illustrates an example of a SIP “invite” message 700 as known in the art. As shown, message 700 includes a request line 702, nineteen header lines 704, and thirteen Session Description Protocol (SDP) lines 706. Each of the header lines includes a header, such as “t:” in header line 705, and a value associated with that header, such as “sip:weber@di.com>” in line 705. Each of the SDP lines includes a type (which is subsequently referred to herein as a “header”), such as “s=” in SDP line 707, and a value. such as “PoC-Call” in line 707. More details on SIP messages can be found in RFC 3261 from the Internet Engineering Task Force (IETF) (hereinafter “RFC 3261”), which is hereby incorporated by reference herein in its entirety. More details on SDP lines can be found in RFC 2327 from the Internet Engineering Task Force (IETF), which is hereby incorporated by reference herein in its entirety.

As described above, in some embodiments, it may be desirable to transmit SIP messages (or any other suitable messages) more quickly than can be achieved when transmitting all of the text for a typical SIP message (e.g., as illustrated in FIG. 6).

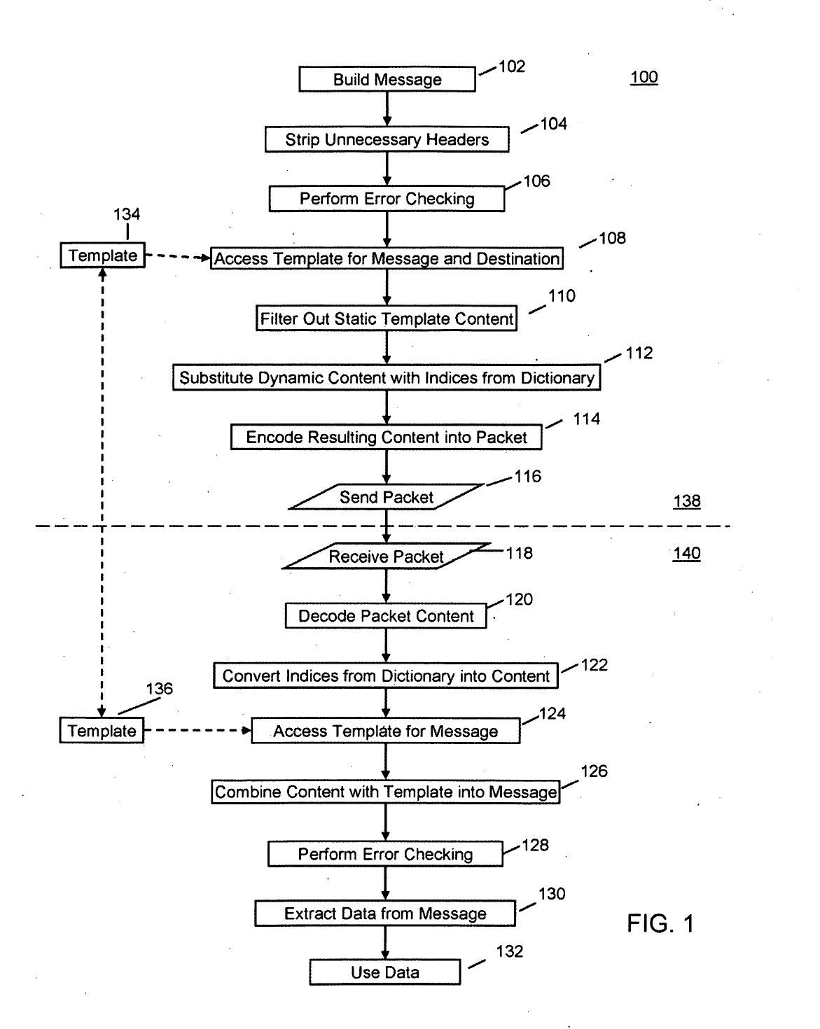

A process 100 for transmitting messages, such as SIP messages or any other suitable messages, is shown in FIG. 1. As illustrated, process 100 begins by building a desired message at 102. This message can be built by any suitable mechanism, and can have any suitable content and/or format. For example, the message can be a SIP Invite message as illustrated in FIG. 6.

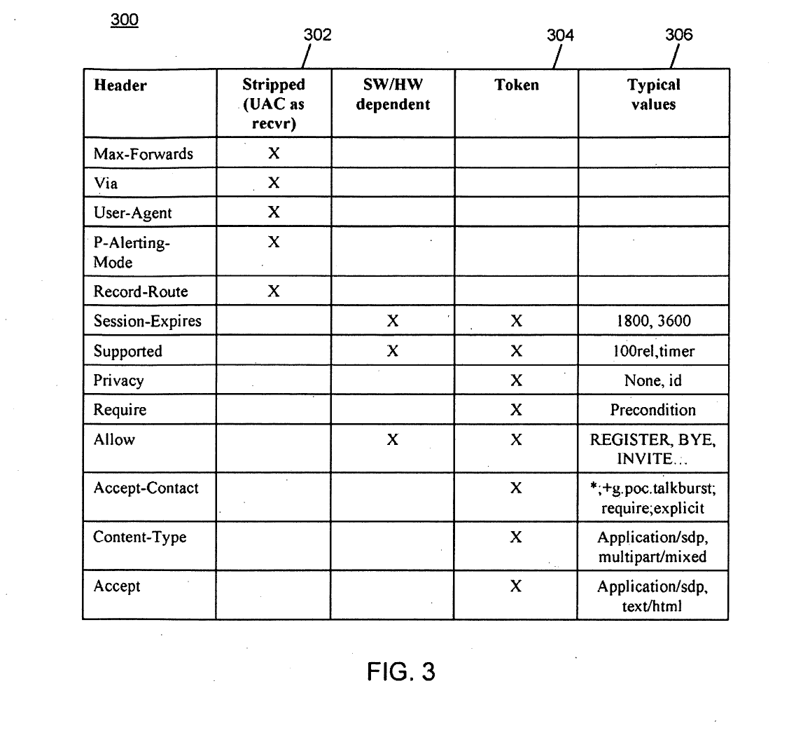

Next, unnecessary header lines and SDP lines can be stripped from the message at 104. Header lines and SDP lines can be determined as being unnecessary based on any suitable criteria or criterion. For example, header lines and SDP lines can be determined as being unnecessary if they only apply to incoming messages when an outgoing message is being processed. As a more detailed example, headers such as Record-Rowe and P-Asserted-Identity may be present in incoming Invite messages, but are not used in outgoing Invite messages. Header lines and SDP lines can additionally or alternatively be determined as being unnecessary if they do not apply to a destination type for a message being processed, as another example. As a more detailed example, if a destination for a message is a SIP User Agent Client (UAC), header lines and SDP lines that only apply to SIP Proxies can be stripped. Examples of headers that can be stripped when a receiver is a User Agent Client are identified by column 302 of table 3(X) of FIG. 3.

Error checking functions can next be performed at 106. The result of these error checking functions can be included in a packet corresponding to the message and used later (e.g., at 128) to determine if the message was not properly reconstructed. For example, the error checking functions can calculate a checksum, such as Cyclic Redundancy Check 16 (CRC-16) for the message, a hash for the message, or any other suitable mechanism that can later be used to determine if the message was reconstructed properly.

At 108, process 100 can then access a template 134 based on message type, destination, and/or any other suitable criterion or criteria. In some embodiments, the template is chosen based on message type because different message types have different content, and thus have different content that remains static. Similarly, in some embodiments, the template is additionally or alternatively chosen based on destination because different destinations have different settings that remain constant. For example, in some embodiments; a specific template can correspond to Invite messages sent to User Agent Clients manufactured by one company and with one set of requirements, while another specific template can correspond to Invite messages sent to User Agent Clients manufactured by another company and with another set of requirements.

Templates, such as template 134 and template 136 (discussed below), can be constructed in any suitable manner. For example, a template can be constructed from a sample message (e.g., such as a SIP Invite message) by classifying each header associated with that message and then using the classification for each header to determine whether that header, and/or its value, should be included in the template. In some embodiments, classifications can include “variable,” “semi-variable,” “semi-constant,” and “other.” A header can be designated as “variable” when the value for the header changes between calls for example. A header can be designated as “semi-variable” when the value for the header is session or registration dependent for example. A header can be designated as “semi-constant” when the value for the header is device dependent based on hardware, software, or both for example. And, a header can be designated as “other” when it does not apply to any of the other classifications, such as because it changes frequently (such as during a SIP Dialog (as defined in RFC 3271)).

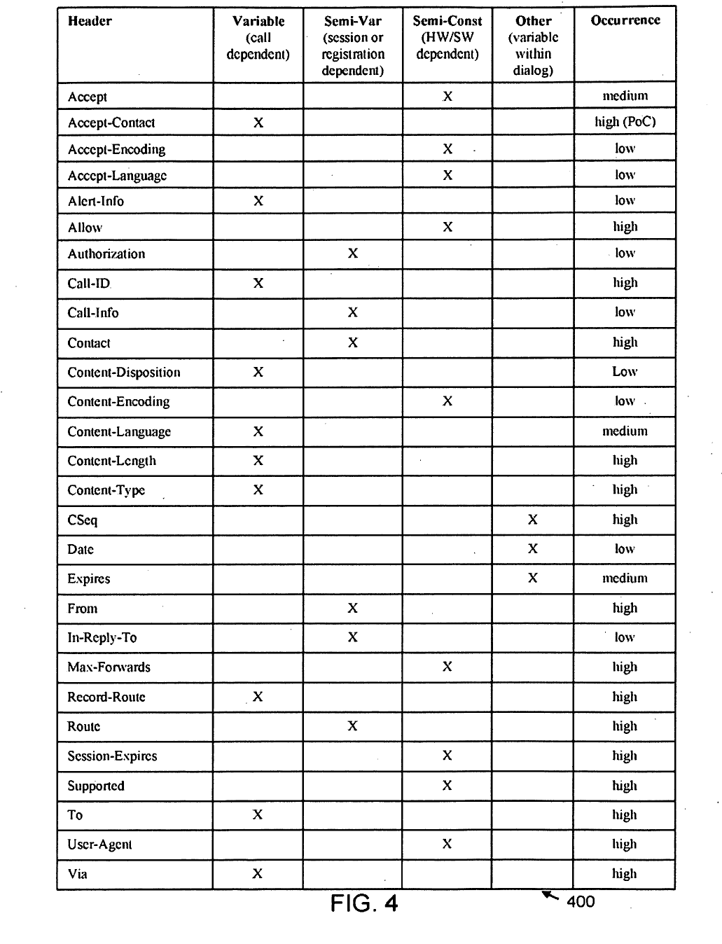

Headers can additionally or alternatively be classified using any other suitable classification(s). For example, headers can additionally be classified based on their frequency of occurrence. It may be desirable to classify a header based on frequency of occurrence because including more frequently used headers in templates may provide a greater statistical performance improvement over including less frequently used headers. Example classifications for different SIP headers, and their relative frequency of occurrence (in some embodiments), are illustrated in table 400 of FIG. 4. Any other suitable classifications can additionally or alternatively be used.

After a header is classified, the header, and/or its value, from the sample message can be used to form part of a template for the corresponding message. For example, in some embodiments, headers classified as semi-constant or semi-variable are included in the template along with their values, and headers classified as variable or other are included in the template without their values. In some embodiments, a part of a value for a header can be used in a template and another part of the header not used in the template. When values (or part(s) of values) for headers are not included in a template, in some embodiments, this can represent that the values (or part(s) of values) are to be sent as part of a packet corresponding to the message. In some embodiments, even if a value (or a part of the value) for a header is included in a template, a value (or a part of the value) for that header can still optionally be sent in a packet and whatever value (or part of the value) is sent (if any) can be used to override the template value.

In addition to being used to construct templates, the classifications can also be used to indicate when a value for a header in a template is to be updated. For example, for semi-variable headers, the values in the template can be updated upon each registration of a corresponding device. As another example, it can be known that headers classified as semi-constant only need to be updated when there is a change in hardware, software, firmware, etc.

As mentioned above, templates can be specific to the destination for a message in some embodiments. For example, because more information may be known in advance about messages of a given type destined for one's own device than is known about messages of the same given type destined for another device (e.g., because all incoming messages might be required to have certain values), the classifications assigned to certain headers for incoming messages of a given type can be different from the classifications assigned to the same headers for outgoing messages. Thus, the classification of headers can depend on whether the message is an incoming message or an outgoing message. As another example, the classifications for headers for a certain type of message can depend on entities, device manufacturers, hardware and/or software models or versions, configuration settings, etc. associated with different destinations.

Next, at 110, content from the message can be filtered out based on the contents of the template accessed at 108. For example, if the template contains a header, and a corresponding value, that were classified as semi-constant, the content in the message corresponding to that header can be filtered out. In this way, content in the message can be reduced based up content that is already in the template (and therefore known in advance to the destination).

After filtering out content of the message, the remaining content in the message can then be compared to the contents of a dictionary known to both the sender and recipient of the message and matching content in the message exchanged for a corresponding index to the content in the dictionary. Any suitable dictionary can be used, and it can be arranged in any suitable manner. For example, a dictionary can include an alphabetically and/or numerically sorted list of strings. As another example, a dictionary can contain a list of strings sorted based on the probability of the string occurring in a message based on any suitable criteria or criterion. As yet another example, a dictionary can contain a list of strings that are ordered by the time at which they were added to the dictionary. The indices to a dictionary can include an identifier of the location of corresponding content in the dictionary, as well as the length of that content,

Strings that can be included in a dictionary in accordance with some embodiments can include Uniform Resource Identifiers (URIs) for known devices, codecs, rtpmap lines, fmtp parameters, etc. Any other strings can additionally or alternatively be included in a dictionary in accordance with some embodiments.

A dictionary can be constructed in any suitable manner. For example, a URI can be added to a dictionary at both a sender and a recipient by the sender inserting the URI at the end of the dictionary and replacing the URI in an Invite request with a corresponding index. Upon the Invite request being received at the recipient, the recipient can associate the index with the Dialog (as defined in RFC 3261) being held with the sender. The recipient can then wait for a message that contains the URI to be received (such as a SIP “ACK” message received in response to a “200 OK” message), and then associate the URI with the index. Once the recipient knows both the index and the URI, the URI can be added to the recipient's dictionary. As another example, a URI can be added to dictionaries at both a sender and a recipient each time a URI not found in the dictionaries is sent in a packet for a message.

The synchronization of dictionaries on different devices can be verified in some embodiments by periodically causing each device to compute a hash of its dictionary, having at least one of the devices provide its hash to the other (e.g., during non-time-sensitive operations), and having the device(s) receiving the hash determine if the two hash values do not match. If the two hashed do not match, the dictionaries are not synchronized. In order to identify which part of the dictionary is out of synchronization, a binary search can be performed on the dictionary, recursively hashing smaller parts of it until the one or more entries responsible for the mismatch are found. Once a loss in synchronization has been detected and the non-aligned entries have been identified, the dictionaries can be re-synchronized by having the devices exchange such non-aligned entries. Any other suitable technique for synchronizing dictionaries can additionally or alternatively be used.

In some embodiments, in addition to or alternatively to using a dictionary to reduce the size of content being transmitted, pointers can be used for strings that are repeated in a message. For example, if a string appears two or more times in a message, the first instance can present the full string the subsequent instances can contain a pointer that indicates to look at the string previously presented. In some embodiments, the full string can be presented in an instance other that the first instance.

In some message types, random numbers are presented as values for headers. These random numbers can have large number of digits. In some embodiments, these large-digit random numbers can automatically be exchanged for shorter random numbers.

Next, at 114, the resulting content can be encoded into a packet. Any suitable approach to encoding the content can be used. For example, content can be encoded in a predetermined arrangement (such as in the order in which the headers corresponding to those values appear in the template) as bit values or integer values in some embodiments. Such bit values can be used to represent values for headers having a finite set of known elements, such as those headers flagged in “token” column 304, and having the typical values shown in column 306, of table 300 of FIG. 3 for example. Such integer values (which can be either fixed or variable length in some embodiments) can be used to represent strings such as IP addresses, port numbers, clock rates and dictionary indices for example. As a more particular example, integer values can be used to represent IP addresses as four bytes.

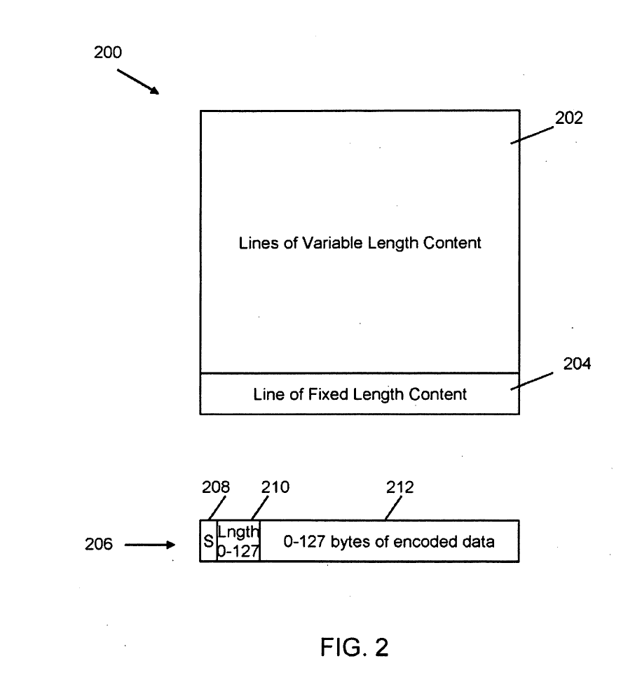

An example of the format for a packet 200 into which the content can be encoded is shown in FIG. 2. As illustrated, packet 200 can have a first section 202 having multiple lines of variable length content and a second section 204 have a single line of fixed length content. Each of these lines can be formatted as shown in line 206. That is, a single byte 208 can be used to indicate whether the next line in the packet is of the same type as the current line, seven bits 210 can be used to indicate the length of the content in the line, 0-127 bytes 212 can be used to represent the content.

As mentioned above, the content contained in the packet can be arranged in a predetermined order in some embodiments. For example, each line of the variable length lines can be used to represent a single value of a header based on the order of the lines and the order of the headers with no corresponding values in the template. In order to preserve the order of content in the packet when content for a variable is not present, the length of the content in a line corresponding to that content can be set to zero in some embodiments.

Although multiple lines of variable length content and a single line of fixed length are illustrated in, and described in connection with. FIG. 2, any suitable number of lines, including none, can be used for variable length content and/or fixed length content.

After the packet has been encoded, the packet can be sent from sender 138 and received at recipient 140 at 116 and 118, respectively. Any suitable mechanism for sending the packet can be used. For example, in some embodiments, the packet may be sent on a control channel on a 1× EV-DO rev. A network.

Next, at 120, the content can be decoded from the packet. For example, as described above, content can be read from the first variable length line in the packet and designated as being a value for the first header with no value in the corresponding template 136 for the message. This can be repeated for the content in the second variable length line, and so on. Content represented by indices in the packet can next be converted to the corresponding strings by looking up those strings in a dictionary using the indices at 122.

A template 136 for the message can then be accessed at 124. This template can be constructed in a similar manner to that described above for template 134, can be fully or partially copied from template 134, or can be created and updated in any suitable manner. For example, templates 134 and 136 can be synchronized in advance of time-sensitive operations (such as operations in which the time to transmit a full message may be unacceptable) during a registration process between the sender and the recipient. The template can next be combined with the content produced from the packet into a message at 126. This can be performed by inserting the content into the open values in the template, by overriding predetermined values in the template, etc.

The integrity of the content in the message can then be confirmed by performing error checking on the message at 128. As described above in connection with 106, a checksum or hash can be generated for the content of the message, and subsequently included in the packet. Once the contents of the packet have been inserted into the message at 126, this checksum or hash can be compared to the contents of the message by calculating another checksum or hash in the same manner as performed at 106 and comparing the resulting values. If there is a difference, an error can be reported. An error may be caused by transmission problems, unsynchronized templates or dictionaries, encoding errors, etc.

Finally, at 130 and 132, the data can be extracted from the message and used as needed.

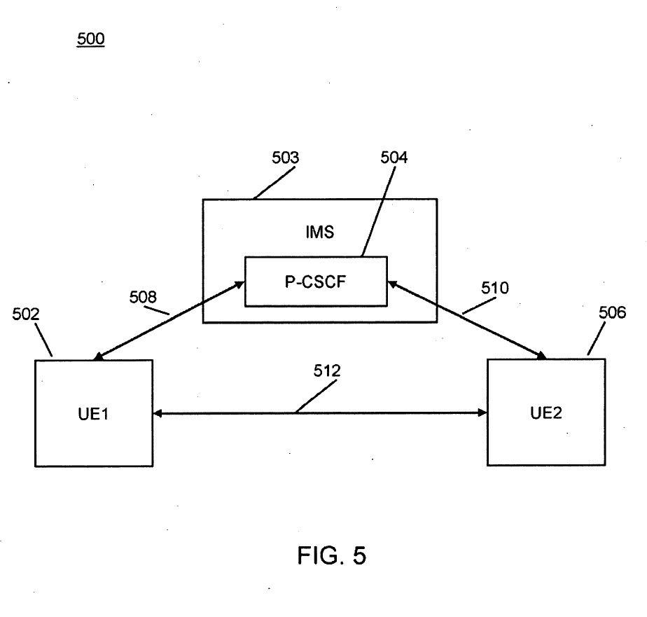

Turning to FIG. 5, a diagram of a system 500 in which template based compression can be used in some embodiments is illustrated. As shown, system 500 can include user equipment (UE) 502, IP Multimedia Subsystem (IMS) 503, and user equipment (UE) 506. UE 502 and UE 506 can be any suitable equipment for digital communications, such as a mobile phone, a video conferencing endpoint, a media server, etc. UE 502 and UE 506 can use any suitable protocol. IMS 503 can be any suitable device for facilitating digital communications between user equipment 502 and user equipment 506, and can include a Proxy-Call Session Control Function (P-CSCF) 504. UE 502, IMS 503, and UE 506 can communicate using communication paths 508, 510, 512. Paths 508, 510, and 512 can be wired and/or wireless and can be implemented using any suitable communication technologies, such as UMTS, GRPS, 1× EV-DO Rev A

For example, when used to implement a Push-To-Talk Over Cellular (POC) system, UE 502 and UE 506 can be implemented as suitable mobile phone handsets and IMS 503 can be implemented as a proxy server between them for setting up the call. The paths between the UE 502, IMS 503, and UE 506 can include wireless paths implemented using 1× EV-DO Rev. A technology. Initially, control channels in path 508 between UE 502 and IMS 503 and in path 510 between IMS 503 and UE 506 can be used to setup a call as described in connection with FIG. 6 for example. This can be performed using template based compression as described above in connection with FIG. 1 for example. Once the call has been setup communication can continue between UE 502 and UE 506 using path 512.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A method for providing template based compression on a message having headers and corresponding values comprising:
stripping a first portion of the headers and the corresponding values from the message;
filtering a second portion of the headers and the corresponding values from the message based on the contents of a template;
substituting a third portion of corresponding values in the message with indices from a dictionary corresponding to the third portion of corresponding values;
encoding the indices and a fourth portion of the corresponding values into a packet in a different relative order than the corresponding values are arranged in the message; and
transmitting the packet to a recipient.

2. The method of claim I. further comprising performing error checking on the headers and the values remaining in the message after the stripping.

3. The method of claim 1, wherein the stripping determines that the first portion is unnecessary.

4. The method of claim 1 further comprising accessing a template that is based on the type of the message.

5. The method of claim 1, further comprising accessing a template that is based on the destination of the message.

6. The method of claim 5, wherein the accessing of the template is based on at least one of hardware and software associated with the destination.

7. The method of claim 5, wherein the accessing of the template is based on an entity associated with the destination.

8. The method of claim 1, further comprising synchronizing templates with the recipient in advance of transmitting the packet.

9. The method of claim 9, wherein transmitting is a time-sensitive operation.

10. The method of claim 1, wherein the message is a Session Initiation Protocol message.

11. A system for providing template based compression on a message having headers and corresponding values comprising:
user equipment that:
strips a first portion of the headers and the corresponding values from the message;
filters a second portion of the headers and the corresponding values from the message based on the contents of a template;
substitutes a third portion of corresponding values in the message with indices from a dictionary corresponding to the third portion of corresponding values;
encodes the indices and a fourth portion of the corresponding values into a packet in a different relative order than the corresponding values are arranged in the message; and
transmits the packet to a recipient.

12. The system of claim 11, wherein the user equipment also performs error checking on the headers and the values remaining in the message after the stripping.

13. The system of claim 11, wherein the stripping determines that the first portion is unnecessary.

14. The system of claim 11, wherein the user equipment also accesses a template that is based on the type of the message.

15. The system of claim 11, wherein the user equipment also accesses a template that is based on the destination of the message.

16. The system of claim 15, wherein the user equipment accesses the template based on at least one of hardware and software associated with the destination.

17. The system of claim 15, wherein the user equipment accesses the template based on an entity associated with the destination.

18. The system of claim 11, wherein the user equipment also synchronizes templates with the recipient in advance of transmitting the packet.

19. The system of claim 19, wherein transmitting is a time-sensitive operation.

20. The system of claim 11, wherein the message is a Session Initiation Protocol message.
